(19) United States
(12) Patent Application Publication
(10) Pub. No.: US 2020/0140083 A1
(43) Pub. Date: May 7, 2020

(54) ROTATIONAL EXPANSION OF PROPULSION SYSTEMS OF A MOVABLE VEHICLE

(71) Applicant: SZ DJI TECHNOLOGY CO., LTD., Shenzhen (CN)

(72) Inventor: Lijian LIU, Shenzhen (CN)

(21) Appl. No.: 16/688,753

(22) Filed: Nov. 19, 2019

Related U.S. Application Data
(63) Continuation of application No. PCT/CN2017/086006, filed on May 25, 2017.

(51) Int. Cl. B64C 39/02; B64C 27/08

(52) U.S. Cl. CPC B64C 39/024; B64C 27/08; B64C 2201/145; B64C 2201/127; B64C 2201/042; B64C 2201/108; B64C 2201/027; B64C 2201/146; B60L 2200/10

(57) ABSTRACT

A movable vehicle includes a main body, a first arm and a second arm each connected to the main body, a first pair of propulsion units positioned at opposite ends of the first arm, and a second pair of propulsion units positioned at opposite ends of the second arm. At least one of a longitudinal length of the first arm or a longitudinal length of the second arm is adjustable between an extended configuration and a retracted configuration.

### CROSS-REFERENCE TO RELATED APPLICATION

This application is a continuation of International Application No. PCT/CN2017/086006, filed May 25, 2017, the entire content of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Unmanned aerial vehicles (UAV), also known as drones, can be used for a variety of applications, such as for imaging (e.g., photography, aerial reconnaissance, mapping, etc.). To realize such applications, a UAV may be equipped with a functional payload, such as sensors, imaging equipment (e.g., cameras), etc. Conventional UAVs typically comprise a large central body/frame to accommodate the weight and/or space of the functional payload. However, the large frame size of such UAVs often impedes the ideal operation of the payload. For instance, the large frame size of such UAVs may obstruct one or more viewing angles for imaging equipment coupled thereto. Moreover, UAVs with large frame sizes require large energy expenditures for operation thereof. While larger batteries may be incorporated to address the increased energy need, such batteries contribute to the overall weight and size of the UAVs.

Conventional UAVs also include at least one rotor assembly, or more depending on the frame size, desired lift-capacity and/or desired flight time. Each rotor assembly generally comprises one or more radially disposed propeller blades, the rotation of which is driven by a motor. The rotation of unprotected propeller blades pose a risk to the operator of the UAV, or other nearby individuals, animals and/or objects. Unprotected propeller blades may also suffer damage themselves upon contacting or impacting an object during rotation thereof.

While certain protective structures have been used to protect the rotor assemblies of UAVs, such structures again come at the expense of one or more functionalities of the UAVs. In particular, protective structures as currently used in the art either impede the movement of the UAV itself, or the movement of one or more components thereof. For instance, the presence of conventional protective structures around the rotor assemblies typically prevents the UAV from achieving a collapsible configuration convenient for transport and/or storage. Further, certain protective structures known in the art are not rigidly attached to the UAV, and may be detached therefrom at undesired or inopportune moments.

### SUMMARY

Described herein are systems, devices, and methods for a movable vehicle comprising a transformable/convertible structure.

In one embodiment, the disclosure described a movable vehicle comprising: a main body comprising a vertical axis; a first arm and a second arm each connected to the main body; a first pair of propulsion units positioned at opposite ends of the first arm; and a second pair of propulsion units positioned at opposite ends of the second arm. In some embodiments, at least one of the first arm or the second arm is configured to rotate about the vertical axis of the main body to allow superposition of one or more portions of the first and second pairs of propulsion units. In some embodiments, the first pair of propulsion units are coplanar with a first horizontal plane. In some embodiments, the second pair of propulsion units are coplanar with a second horizontal plane. In some embodiments, the first horizontal plane is positive under, or alternatively positioned above, the second horizontal plane.

In some embodiments, the vertical axis of the movable vehicle passes through a center of weight of the main body.

In some embodiments, at least one of the first arm or the second arm of the movable vehicle is configured to rotate about the vertical axis between an open configuration and a closed configuration.

In some embodiments, the closed configuration corresponds to the superposition of one or more portions of the first and second pairs of propulsion units. For instance, in some embodiments, a longitudinal axis of the first arm is substantially coincident with a longitudinal axis of the second arm in the closed configuration. Conversely, the longitudinal axis of the first arm is substantially orthogonal to a longitudinal axis of the second arm in the open configuration, in some embodiments.

In some embodiments, a longitudinal length of the first arm and/or a longitudinal length of the second arm is adjustable. In some embodiments, the longitudinal length of the first arm and the longitudinal length of the second arm are each independently adjustable between an extended configuration and a retracted configuration. In some embodiments, the longitudinal length of the first arm and the longitudinal length of the second arm each comprise a maximum, predetermined value in the extended configuration and/or each comprise a minimum, predetermined value in the retracted configuration.

In some embodiments, the movable vehicle comprises one or more locking mechanisms configured to lock the first and second arms in the open or closed configuration and/or to lock the first and second arms in the extended or retracted configuration.

In some embodiments, each propulsion unit of the movable vehicle comprises a rotor. In some embodiments, each propulsion further comprises a protective shield configured to protect the rotor associated therewith. In such embodiments, each protective shield comprises a central hub, a peripheral region, and one or more protective spokes extended radially from the central hub to the peripheral region. In some embodiments, the central hub of each protective shield is coupled to a drive shaft of the rotor associated therewith.

In some embodiments, the movable vehicle is an unmanned movable vehicle. In some embodiments, the movable vehicle is an unmanned aerial vehicle.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the disclosure are utilized, and the accompanying drawings of which:

FIG. 1 provides a top down view of a movable vehicle in an open and extended configuration, according to one embodiment.

FIG. 2 provides a cross-sectional, side view of a propulsion unit associated with the movable vehicle of FIG. 1.

FIG. 3 provides a top down view of the movable vehicle of FIG. 1 in an open and retracted configuration, according to one embodiment.

FIGS. 4A-4F provide various views of the movable vehicle of FIG. 1 in an closed and extended configuration, according to one embodiment.

FIGS. 5A-5D provide various views of the movable vehicle of FIG. 1 in an closed and retracted configuration, according to one embodiment.

FIGS. 6A-6B provide a top down view of the movable vehicle of FIG. 1 in an open and closed configuration, respectively, where the movable vehicle comprises one or more locking mechanisms, according to one embodiment.

FIG. 7 provides a simplified block diagram of a control system for controlling a movable vehicle, according to one embodiment.

FIG. 8 provides a flowchart of a method for transforming a movable vehicle between two or more configurations, according to one embodiment.

### DETAILED DESCRIPTION

In the following description, certain specific details are set forth in order to provide a thorough understanding of various embodiments of the disclosure. However, one skilled in the art will understand that the disclosure may be practiced without these details. Moreover, while various embodiments of the disclosure are disclosed herein, many adaptations and modifications may be made within the scope of the disclosure in accordance with the common general knowledge of those skilled in this art. Such modifications include the substitution of known equivalents for any aspect of the disclosure in order to achieve the same result in substantially the same way.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise.

Reference throughout this specification to “one embodiment” or “an embodiment” means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

Various embodiments described herein are directed to systems, devices, and methods for a movable vehicle (e.g., an unmanned aerial vehicle) comprising a transformable/convertible structure. The transformable/convertible structure enables the movable vehicle to achieve a plurality of configurations that facilitate particular operations thereof. For instance, certain configurations enable the movable vehicle to move in air (e.g., land, take off, fly, etc.), while other configurations enable the movable vehicle to assume a compact shape for ease of transport and/or storage, etc.

The transformable/convertible structure additionally enables the movable vehicle to have a small, efficient body/frame size, thereby enabling substantially unobstructed viewing angles for imaging equipment coupled thereto. Such improvement in imaging functionality may be particularly beneficial for photography applications, such as those involving the capture of self-portrait photographs (or “selfies”).

The movable vehicles described herein also comprise protective shields configured to safeguard the propulsion units of the vehicles. These protective shields are unique in that they do not hinder the ability of the transformable/convertible nature of the movable vehicle.

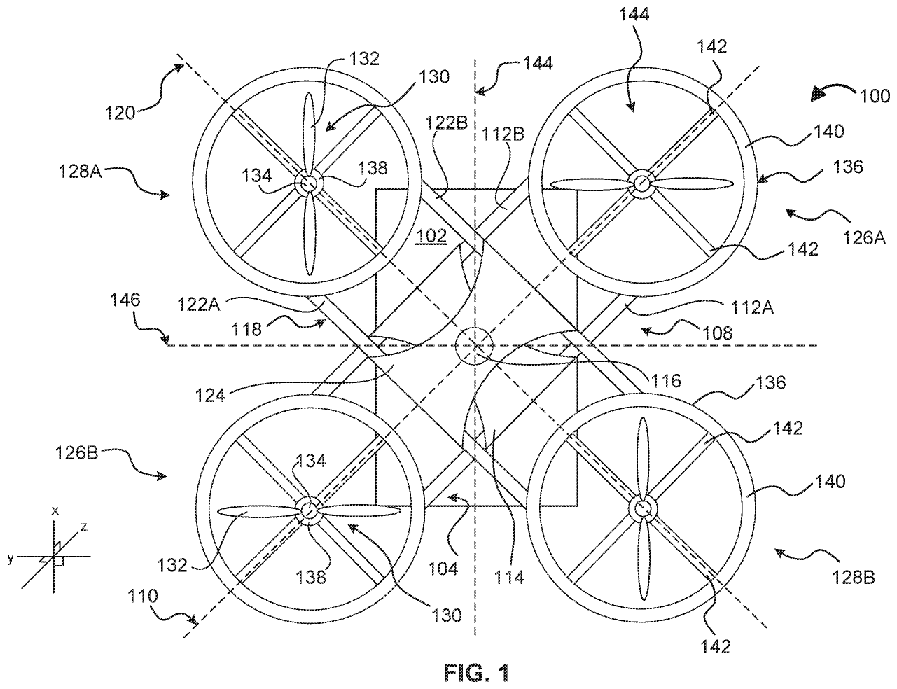

Referring now to FIG. 1, an exemplary collapsible movable vehicle 100 is depicted in accordance with one embodiment. The movable vehicle 100 may be implemented in combination with other devices/features/components described herein, such as those described with reference to other embodiments and FIGS. The movable vehicle 100 may also be used in various applications and/or in permutations, which may or may not be noted in the illustrative embodiments described herein. For instance, the movable vehicle 100 may include more or less features/components than those shown in FIG. 1, in some embodiments. Moreover, the movable vehicle 100 is not limited to the size, shape, number of components, etc. specifically shown in FIG. 1.

In some embodiments, the movable vehicle 100 may be utilized in any suitable environment such as in the air, water, space, on the ground, underground, or any combination thereof. The movable vehicle 100 may also be configured to move in any direction (e.g., up to three degrees of rotation and three degrees of translation) in any of these environments. In some embodiments, one or more engines or motors (e.g., DC motor(s), AC motor(s)) may cause the movable vehicle 100 to move in a desired environment. Moreover, certain components of the movable vehicle 100 may be powered by electrical energy, solar energy, magnetic energy, chemical energy, wind energy, nuclear energy, combinations thereof, etc.

In some embodiments, the movable vehicle 100 described herein may be an unmanned movable vehicle. In such embodiments, the movable vehicle 100 may be autonomously controlled via a processor or controller associated therewith and/or remotely controlled by a remote device.

The movable vehicle 100 described herein may have any suitable size, shape and/or dimensions configured to allow movement of said vehicle 100, as well as provide one or more optional functionalities. For instance, in some embodiments, the movable vehicle may have a size, shape and/or dimensions suitable to support a payload, such as equipment, instruments, imaging devices, etc. In some embodiments, the movable vehicle 100 may have a size, shape and/or dimensions suitable to support a human occupant. In some embodiments, the movable vehicle 100 may have a size, shape and/or dimensions suitable to allow said vehicle 100 to be lifted and/or easily transported by a human.

In some embodiments, the components of the movable vehicle 100 may be comprised of flexible materials, rigid materials, or a combination thereof. Suitable materials include, but are not limited to, plastics (e.g., acrylonitrile butadiene styrene (ABS), polystyrene, polypropylene, etc.), composite materials (e.g., carbon fiber, fiber glass, etc.), wood, metals (e.g., aluminum, titanium, stainless steel, etc.), combinations thereof, or any other like material as would be appreciated by skilled artisans upon reading the present disclosure.

As discussed in greater detail herein, certain components of the movable vehicle 100 may be coupled together in a manner configured to allow rotational motion thereof via one or more hinges, one or more ball bearings, or other suitable rotary joint/pivotal coupling(s). Certain components of the movable vehicle 100 may be coupled together in a manner configured to allow linear motion thereof via one or more sliding mechanisms, one or more cinching mechanisms, one or more ratcheting mechanisms, one or more telescoping mechanisms, etc. Certain components of the movable vehicle 100 may be fixedly coupled together via one or more screws, nails, bolts, clips, pins, or other such suitable fastener.

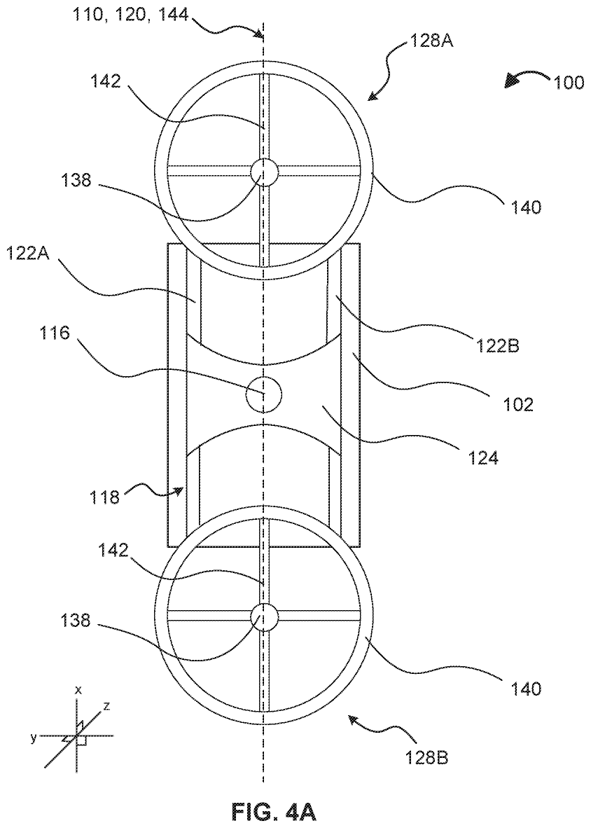

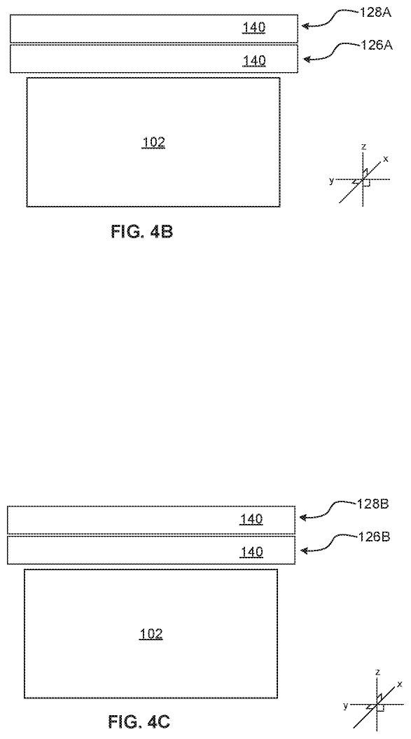

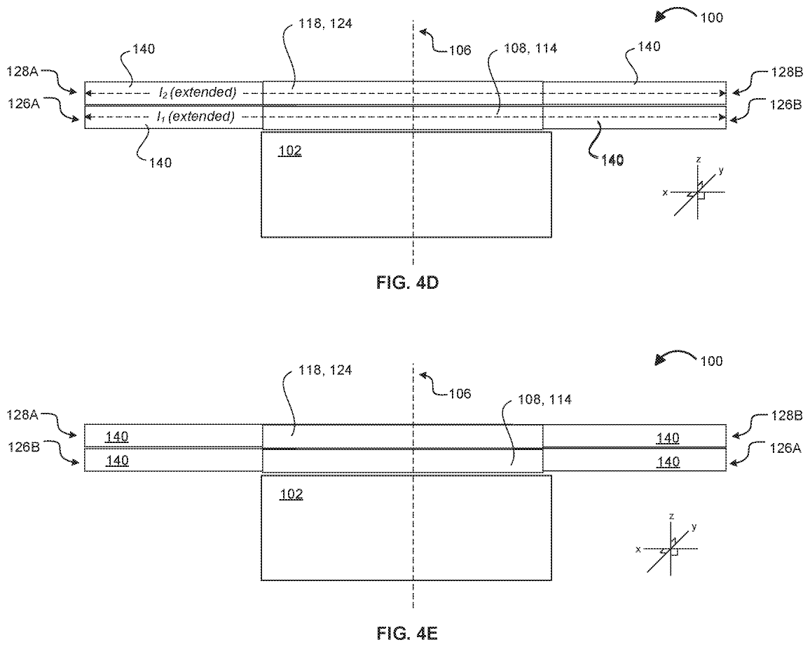

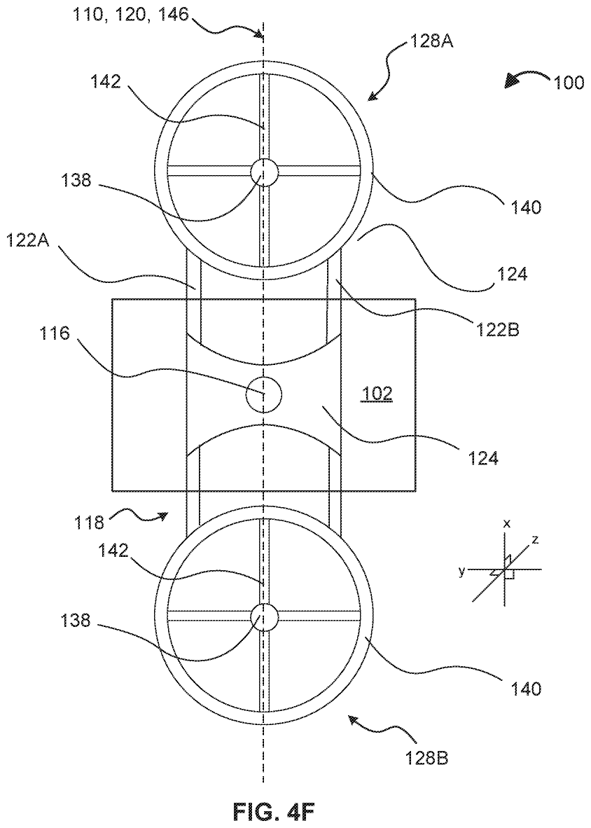

As shown in FIG. 1, the movable vehicle 100 includes a main body 102. The upper surface 104 of the main body 102 may be described as extending substantially along a first horizontal plane (e.g., a plane defined by the x-y axes of FIG. 1). The main body 102 may also have a vertical axis 106 (see, e.g., FIGS. 4D-4E) oriented substantially orthogonal to the first horizontal plane. In some embodiments, this vertical axis 106 may pass through a center of weight of the main body 102.

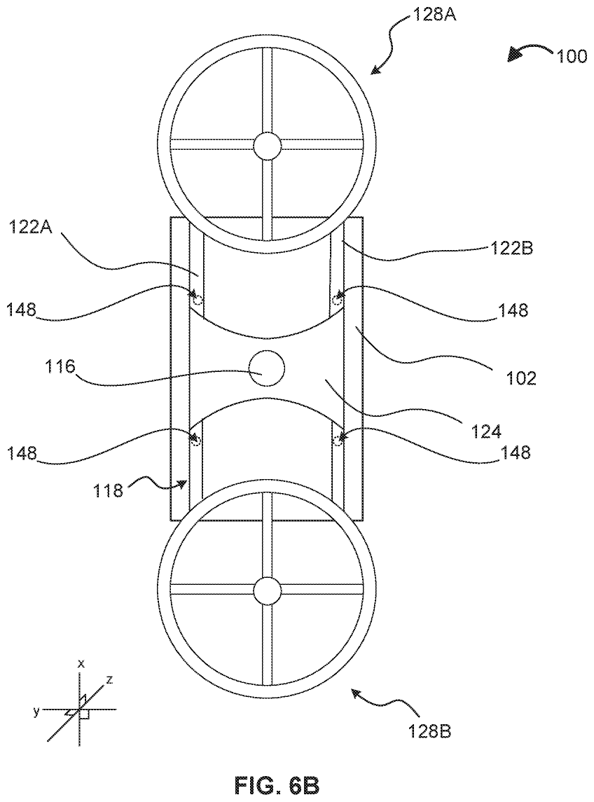

In some embodiments, the main body 102 may comprise a cavity region (not shown in FIG. 1). One or more electrical components configured to control various aspects of the operation of the movable vehicle 100 may be disposed within this cavity region. These electrical components may include, but are not limited to, an energy source (e.g., one or more batteries), a flight control or navigation module, a communication module (e.g. a wireless transceiver), a global positioning system (GPS) module, actuator(s) (e.g., an electric motor configured to actuate one or more propulsion units associated with the movable vehicle 100), one or more sensors (e.g., motion sensors, inertial sensors, proximity sensors), etc. A more detailed description of exemplary modules and/or sensors is provided with respect to FIG. 6.

In some embodiments, the main body 102 may be configured to support a payload. The payload may be coupled to any portion (e.g., an exterior portion) of the main body 102. In some embodiments, the payload may be coupled to a separate frame or carrier that is itself coupled to a portion of the main body 102. In some embodiments, the payload may be incorporated within the cavity region of the main body 102. The payload may also be coupled to the main body 102 in any manner configured to allow or prevent motion (e.g., rotation) of the payload with respect to the main body 102. The payload may also be configured to perform one or more functions (e.g., sensing, mapping, imaging, surveillance, etc.). For example, in some embodiments, the main body 102 may be configured to support an imaging device (e.g., a camera, video camera, etc.). In some embodiments, the main body 102 may be configured to support large payloads, such as a human occupant.

The main body 102 may comprise any suitable size, shape and/or dimensions. In some embodiments, the size, shape and/or dimensions of the main body 102 are not constrained/limited by the configuration of the components coupled thereto, such as the propulsion units, as is common with conventional movable vehicles. For instance, the unique configuration of the rotatable and retractable propulsion units associated with the main body 102 may permit smaller sizes of the main body 102. Such smaller sizes of the main body 102 may be beneficial in extending the battery life, and thus the “flying” time of the movable vehicle 100. Smaller sizes of the main body 102 may also enable the movable vehicle 100 to maintain a more compact and less obtrusive profile, which may be advantageous in certain imaging applications (e.g., the taking of a self-portrait photograph, commonly referred to as a “selfie”).

In some embodiments, the main body 102 may have a maximum dimension (e.g., length, width, height, diameter, diagonal, etc.) in a range from about 5 m to about 100 mm. In some embodiment, this maximum dimension may be in a range from about 3 m to about 100 mm, about 1 m to about 100 mm, about 700 mm to about 100 mm, about 400 mm to about 100, about 5 m to about 300 mm, about 3 m to about 300 mm, about 1 m to about 300 mm, about 700 mm to about 300 mm, about 400 mm to about 300 mm, about 5 m to about 500 mm, about 3 m to about 500 mm, about 1 m to about 500 mm, about 700 mm to about 500 mm, about 5 m to about 500 mm, about 3 m to about 500 mm, about 1 m to about 500 mm, about 700 mm to about 500 mm, about 5 m to about 900 mmm, about 3 m to about 900 mm, or about 2 m to about 900 mm. It is of note that this maximum dimension may be larger or smaller than the values provided herein depending on the desired application.

As also shown in FIG. 1, the movable vehicle 100 includes a first arm 108 coupled to the main body 102. The first arm 108 may be movable relative to the main body 102 of the movable vehicle 100, where such motion may include rotating, extending, shrinking, retracting, telescoping, folding, etc. For instance, in some embodiments, the first arm 108 may be configured to rotate about the vertical axis (e.g., the yaw axis) 106 of the main body 102 in a clockwise direction and/or a counterclockwise direction. In some embodiments, the angle of rotation of the first arm 108 about the vertical axis 106, and in a horizontal plane, may encompass a range anywhere from 0° to 360°.

The first arm 108 comprises a longitudinal axis 110, and a longitudinal length, l₁, which may also be adjustable as described in greater detail below. For instance, the longitudinal length, l₁, of the first arm 108 may be larger when in the fully “extended” configuration as compared to the fully “retracted” configuration. In some embodiments, the longitudinal length, l₁, of the first arm 108 may range from about 5 m to 100 mm in the fully “extended” configuration. In the fully “retracted” configuration, the first arm 108 may have a longitudinal length, l₁, that ranges anywhere from about 0.5% to about 95% of the longitudinal length of said arm when in the fully “extended” configuration.

In the embodiment of FIG. 1, the first arm 108 may comprise a first pair of support members 112A, 112B in spaced relation with one another. These support members 112A, 112B may also be oriented substantially parallel with one another. Further, each of the support members 112A, 112B may be linear or curvilinear.

In some embodiments, at least one of the support members 112A, 112B of the first arm 108 may comprise a cavity region extending the longitudinal length thereof, which may serve as a conduit for connecting operating components of the movable vehicle 100. For example, at least one of the support members 112A, 112B may be formed as a hollow structure comprising one or more electrical connections (e.g. electrical wiring) therein. These electrical connections may serve to electrically couple an energy source and/or control module associated with the main body 102 to one or more electric components associated with the first arm 108, such as a propulsion unit.

The first arm 108 may further comprise a first crossbar 114, or other like support structure, coupled to the first pair of support members 112A, 112B. The first crossbar 114 may be oriented at any suitable angle relative to the support members 112A, 112B, such as substantially orthogonal thereto. In some embodiments, this first crossbar 114 may be substantially coplanar with the first pair of support members 112A, 112B. However, in some embodiments, one or more portions of this first crossbar 114 may comprise a curved (e.g., a convex) shape extending above the plane of the support members 112A, 112B.

In some embodiments, the first crossbar 114 may be located within a proximal (e.g., center) region of the first arm 108. In one particular embodiment, the first crossbar 114 may be located substantially equidistance from the distal ends of the first arm 108. Moreover, one or more portions of the first crossbar 114 may serve as a point of attachment to the main body 102 of the movable vehicle 100. For instance, as shown in FIG. 1, the first crossbar 114 may comprise an opening at, or in proximity to, its midpoint through which a fastening component 116 (e.g., a rod, bolt, pin, etc.) may be disposed. This fastening component 116 may be configured to couple the first crossbar 112, and thus the first arm 108, to the main body 102, yet still allow rotation of the first arm 108 about the vertical axis 106 of the main body 102.

As further shown in FIG. 1, the movable vehicle 100 comprises a second arm 118 positioned above the first arm 108 relative to the main body 102. The second arm 118 may also be movable relative to the main body 102, where such motion may include rotating, extending, shrinking, retracting, telescoping, folding, etc. For instance, in one embodiment, the second arm 118 may be configured to rotate about the vertical axis 106 of the main body 102 in a clockwise direction and/or a counterclockwise direction. In some embodiments, the angle of rotation of the second arm 118 about the vertical axis 106, and in a horizontal plane, may encompass a range anywhere from 0° to 360°.

The second arm 118 comprises a longitudinal axis 120, and a longitudinal length, l₂, which may also be adjustable as described in greater detail below. For instance, the longitudinal length, l₂, of the second arm 118 may be larger when in the fully “extended” configuration as compared to the fully “retracted” configuration. In some embodiments, the longitudinal length, l₂, of the second arm 118 may range from about 5 m to 100 mm in the fully “extended” configuration. In the fully “retracted” configuration, the second arm 118 may have a longitudinal length, l₂, that ranges anywhere from about 0.5% to about 95% of the longitudinal length of said arm when in the fully “extended” configuration.

As also described in greater detail below, the relative angle between the longitudinal axes 110, 120 of the first and second arms 108, 118, respectively, may be selected for certain modes of operation of the movable vehicle 100. In some embodiments, the longitudinal axes 110, 120 of the first and second arms 108, 118, respectively, may be oriented substantially orthogonal to one another in an “open” configuration, which may be particularly suited for enabling the movable vehicle 100 to move in an environment described herein (e.g., air). In some embodiments, the longitudinal axes 110, 120 of the first and second arms 108, 118, respectively, may be substantially coincident with one another in a “closed” configuration, which may be particularly suited for situations in which the movable vehicle 100 needs to be transported and/or stored. Each arm 108, 116 may be independently configured to rotate about the vertical axis 106 of the main body 102 through any range of horizontal angles (e.g., 0° to) 360° to achieve a desired configuration, in some embodiments. In alternative embodiments, only one of said arms 108, 116 may be configured to rotate about the vertical axis 106 to achieve the desired configuration.

Similar to the first arm 108, the second arm 118 may comprise a second pair of support members 122A, 122B in spaced relation with one another. These support members 122A, 122B may also be oriented substantially parallel with one another. Further, each of the support members 122A, 122B may be linear or curvilinear.

In some embodiments, at least one of the support members 122A, 122B of the second arm 118 may comprise a cavity region extending the longitudinal length thereof, which may serve as a conduit for connecting operating components of the movable vehicle 100. For example, at least one of the support members 122A, 122B may be formed as a hollow structure comprising one or more electrical connections (e.g. electrical wiring) therein. These electrical connections may serve to electrically couple an energy source and/or control module associated with the main body 102 to one or more electric components associated with the first arm 118, such as a propulsion unit.

The second arm 118 may additionally comprise a second crossbar 124, or other like support structure, coupled to the second pair of support members 122A, 122B. The second crossbar 124 may be oriented at any suitable angle relative to the support members 122A, 122B, such as substantially orthogonal thereto. In some embodiments, this second crossbar 124 may be substantially coplanar with the second pair of support members 122A, 122B. However, in some embodiments, one or more portions of this second crossbar 124 may comprise a curved (e.g., a convex) shape extending above the plane of the support members 122A, 122B.

In some embodiments, the second crossbar 124 is located within a proximal (e.g., center) region of the second arm 118. In one particular embodiment, the second crossbar 124 may be located substantially equidistance from the distal ends of the second arm 118. Moreover, one or more portions of the second crossbar 124 may serve as a point of attachment to the main body 102 of the movable vehicle 100. For instance, as shown in FIG. 1, the second crossbar 124 may comprise an opening coincident with the opening of the first crossbar 112, and through which the aforementioned fastening component 116 may be disposed. This fastening component 116 may thus also be configured to couple the second crossbar 124, and consequently the second arm 118, to the main body 102, yet still allow rotation of the second arm 118 about the vertical axis 106 of the main body 102.

It is of note that the movable vehicle 100 is not limited to two rotatable and/or retractable arms, but may comprise any number (e.g., 2, 3, 4, 5, 6, 7, 8, etc.) of rotatable and/or retractable arms.

As further shown in FIG. 1, the first and second arms 108, 118 each comprises a pair of propulsion units coupled thereto. For example, a first pair of propulsion units 126A, 126B may be coupled to the distal portions of the first arm 108, and a second pair of propulsion units 128A, 128B may be coupled to the distal portions of the second arm 118. Further, the first pair of propulsion units 126A, 126B may be substantially coplanar with a second horizontal plane, and the second pair of propulsion unit 128A, 128B may be substantially coplanar with a third horizontal plane. Given the relative position of the first and second arms 108, 118, the third horizontal plane is positioned above the second horizontal plane. In some embodiments, the first pair of propulsion units 126A, 126B may not be substantially on the same plane as each other. For instance, the propulsion units can be placed at different elevation levels or tilted towards or against each other. Likewise, the second pair of propulsion unit 128A, 128B may not be substantially on the same plane. In some embodiments, the two pairs of propulsion units can be positioned such that they can support the movement of the movable vehicle 100 in a desired environment and allow the first and second arms 108, 118 to be engaged in the open and closed configurations as described herein.

The propulsion units 126A/126B, 128A/128B may be configured to allow the movable vehicle 100 to move in an environment described herein (e.g., to take off, land, hove, or otherwise fly in air). In some embodiments, each of the propulsion units 126A/126B, 128A/128B may comprise a rotor 130. Such rotors may include one or more rotor blades 132 coupled to a drive shaft 134. This drive shaft 134 may be driven by one or more motors (e.g., DC motor(s), AC motor(s), etc.) coupled thereto.

In some embodiments, each of the rotors 130 may be configured to rotate at a same speed, yet this need not be the case. For example, in some embodiments, the rotors 130 associated with the first pair of propulsion units 126A/126B may rotate according to a first speed, whereas the rotors 130 associated with the second pair of propulsion units 128A/128B may rotate according to a second speed, different from the first speed. In more embodiments, each rotor 130 may rotate according to its own, unique speed.

In some embodiments, one or more of the rotors 130 may be horizontally oriented (e.g., extend substantially along a horizontal plane). However, in some embodiments, one or more of the rotors 130 may be oriented at a predetermined angle (e.g., ranging from about 0° to about) 90° relative to such horizontal plane.

In some embodiments, the rotational speed and/or aforementioned angle (e.g., relative to a horizontal plane) associated with each rotor 130 may be selected to ensure that the movable vehicle 100 is properly balanced during movement thereof. The ability to select and adjust/tune these characteristics associated with each rotor 130 may be particularly advantageous given that the second pair of propulsion units 128A/128B (and thus the rotors 130 associated therewith) are located above the first pair of propulsion units 126A/126B (and rotors 130 associated therewith).

Each of the propulsion units 126A/126B, 128A/128B may additionally comprise a protective shield 136 configured to protect the rotor 130 associated therewith. This protective shield 136 may protect its associated rotor 130 from contacting or impacting an object during movement (e.g., flight) of the movable vehicle 100.

As shown in the embodiment of FIG. 1, each protective shield 136 may comprise a central hub 138, an outer peripheral region 140, and one or more protective members (protective spokes) 142 extending radially from, and coupling, the central hub 138 to the outer peripheral region 140. In some embodiments, the outer peripheral region 140 may comprise a substantially circular (ring-type) shape having a diameter suitable to encompass the associated rotor and not hinder the rotation thereof. In some embodiments, each protective shield 136 may comprise any number of protective spokes 142, such as 1, 2, 3, 4, 5, 6, 7, 8, etc. spokes. Regardless of the number of protective spokes 142, each protective shield 136 may comprise a suitable number of apertures 144 between said protective spokes 142 to ensure that the protective spokes 142 do not negatively impact airflow from the rotors 130.

In some embodiments, one or more components of the protective shield 136 may comprise a cavity region, which may serve as a conduit for connecting operating components of the movable vehicle 100. For example, the peripheral region 140, at least one protective member 142, and the central hub 138 of each propulsion unit may be formed as hollow structures comprising one or more electrical connections (e.g. electrical wiring) therein. These electrical connections may serve to electrically couple an energy source and/or control module associated with the main body 102 to the rotor 130. In some embodiments, a motor and/or a portion of the drive shaft 134 of the rotor 130 associated therewith may be present within the cavity region of each central hub 138 or otherwise coupled thereto.

In some embodiments, the protective spokes 142 of each protective shield 136 may be positioned below the rotor blades 132 of the rotor 130 associated therewith. In some embodiments, the protective spokes 142 of each protective shield 136 may be positioned above the rotor blades 132 of the rotor 130 associated therewith. In some embodiments, at least one protective spoke 142 of each protective shield 136 may be positioned below the rotor blades 132 of the rotor 130 associated therewith, and at least one protective spoke of each protective shield 136 may positioned above said rotor blades 132.

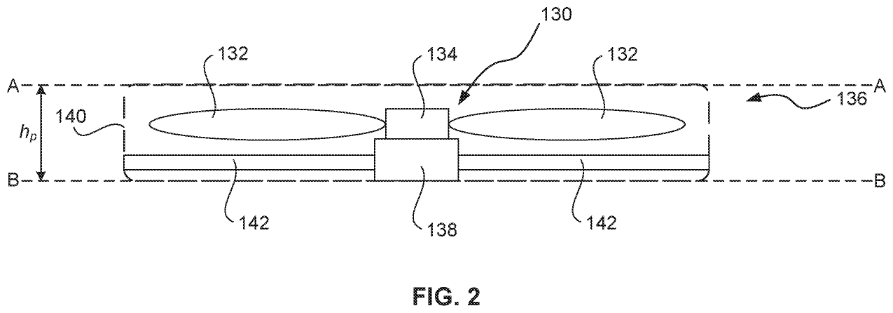

In some embodiments, a height, hₚ, of the outer peripheral region 140 of each protective shield 136 is selected so as to ensure that the rotor 130, and particularly the rotor blades 132 thereof, do not extend above or below the upper and lower surfaces of the protective shield 136. FIG. 2 provides a cross-sectional, side view of an exemplary protective shield 136 for reference, where upper and lower surface thereof is denoted by lines A and B, respectively.

As shown in the embodiment of FIG. 1, one or more portions of peripheral region 140 of each protective shield 136 are attached to the distal end of its respective arm, and specifically to the support members thereof. In some embodiments, each protective shield 136 is rigidly/fixedly coupled to its respective arm. The size, shape and/or dimensions of each protective shield 136 does not limit the movement of the arm to which is attached.

As indicated above, the first and second arms 108, 116 of the movable vehicle 100 can be moved (such as by rotating, extending, shrinking, rotating, telescoping, folding, translating, etc.) relative to the main body 102 thereof, thus allowing the movable vehicle 100 to assume one or more different configurations. The movable vehicle 100 may assume any number of configurations. Certain configurations may only be usable or functional during certain phases of operation of the movable vehicle 100. In some embodiments, each configuration may provide a different functionality to the movable vehicle 100.

In one embodiment, the movable vehicle 100 may assume an open and extended configuration. In the open and extended configuration, (a) the longitudinal axes 110, 120 of the first and second arms 108, 118 respectively, are oriented substantially orthogonal to one another, and (b) the longitudinal lengths, l₁, l₂, of first and second arms 108, 118, respectively are fully extended (i.e., have achieved their maximum allowed value). FIG. 1 illustrates an example in which the movable vehicle 100 is in the open and extended configuration. This open and extended configuration may enable the movable vehicle 100 to take off, land, move in the air, hover, etc.

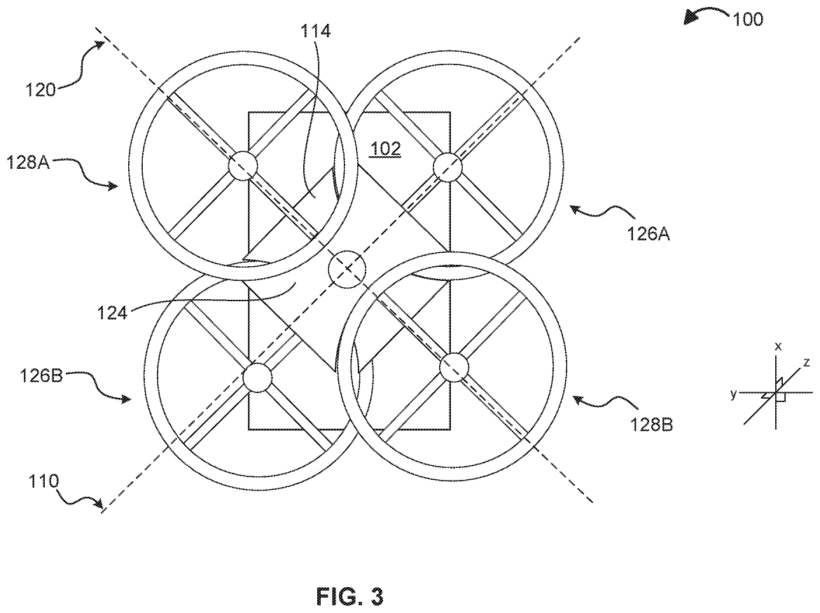

In one embodiment, the movable vehicle 100 may assume an open and retracted configuration, as shown in the exemplary embodiment of FIG. 3. For clarity, some of the features of the movable vehicle 100 are omitted in FIG. 3. In the open and retracted configuration, the longitudinal axes 110, 120 of the first and second arms 108, 118 respectively, are again oriented substantially orthogonal to one another; however, the longitudinal lengths, l₁ l₂, of first and second arms 108, 118, respectively are fully retracted (i.e., have achieved their minimum allowed value). For the first arm 108, the curvature of peripheral region 140 of each protective shield 136 may be substantially similar to adjacent convex portions of the first crossbar 114 such that a portion of said peripheral region 140 fits snugly against and/or physically abuts the convex portions of the first crossbar 114. Similarly, for the second arm 118, the curvature of peripheral region 140 of each protective shield 136 may be substantially similar to adjacent convex portions of the second crossbar 124 such that a portion of said peripheral region 140 fits snugly against and/or physically abuts the convex portions of the second crossbar 124.

In one embodiment, the movable vehicle 100 may assume a closed and extended configuration, as shown in the exemplary embodiment of FIGS. 4A-4E. For clarity, some of the features of the movable vehicle 100 are omitted in FIGS. 4A-4E. In the closed and extended configuration, the longitudinal axis 110 of the first arm 108 is substantially coincident with the longitudinal axis 118 of the second arm 116, and (b) the longitudinal lengths, l₁, l₂, of first and second arms 108, 118, respectively are fully extended (i.e., have achieved their maximum allowed value). As evident from the side, front and rear views provided in FIGS. 4A-4C, respectively, the closed and extended configuration corresponds to the superposition of the first and second pairs of propulsion units 126A/126B, 128A/128B and the maximum lengthwise extension of the first and second arms 108, 116.

As the first and/or second arm 108, 118 may rotate about the vertical axis 106 of the main body 102 in a clockwise or counterclockwise direction, the closed and extended configuration encompasses instances in which propulsion units 128A and 128B are positioned directly above (i.e., superposed on) propulsion units 126A and 126B, respectively (see, e.g., FIG. 4D), and instances in which propulsion units 128A and 128B are positioned directly above (i.e., superposed on) propulsion units 126B and 126A, respectively (see FIG. 4E).

As also shown in the embodiments of FIGS. 4A-4E, the longitudinal axes 110, 120 of the first and second arms 108, 118, respectively, may be substantially coincident not only with each other when in the open and extended, but also with a longitudinal axis 144 of the main body 102 of the movable vehicle 100. However, in some embodiments, the longitudinal axes 110, 120 of the first and second arms 108, 118, respectively, may be substantially coincident with each other and a with lateral axis 146 of the main body 102 when in the open and extended configuration (see, e.g., FIG. 4F). It is important to note, however, that the main body 102 may comprise any suitable shape and/or dimensions, and is thus not limited to the rectangular shape shown in the FIGS.

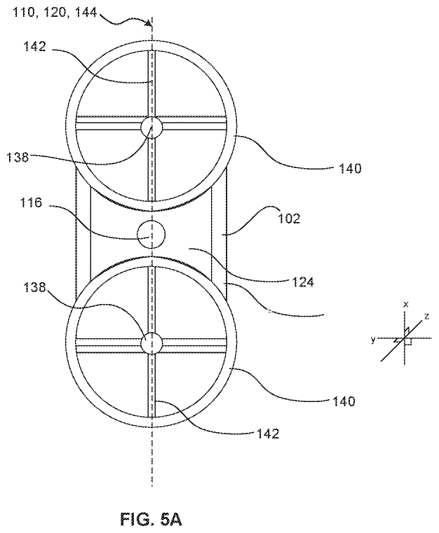

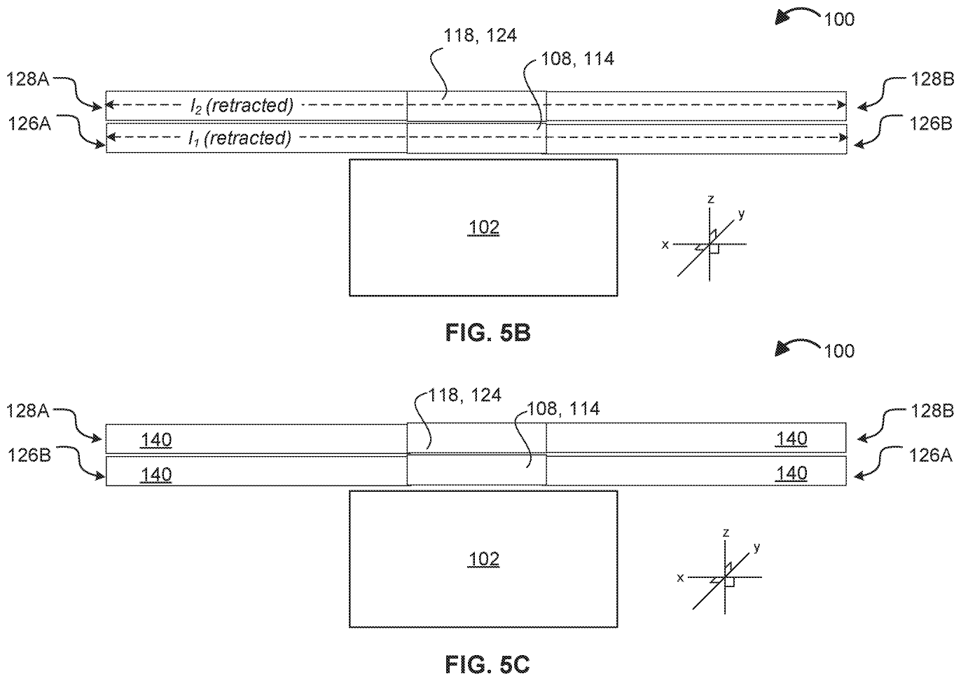

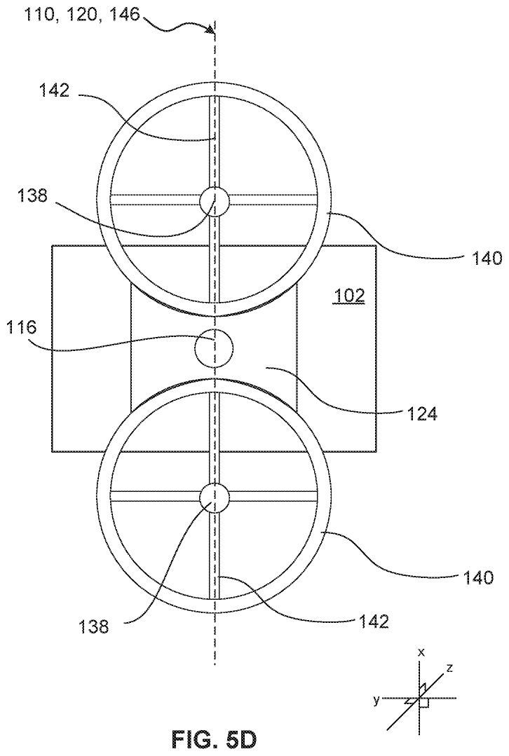

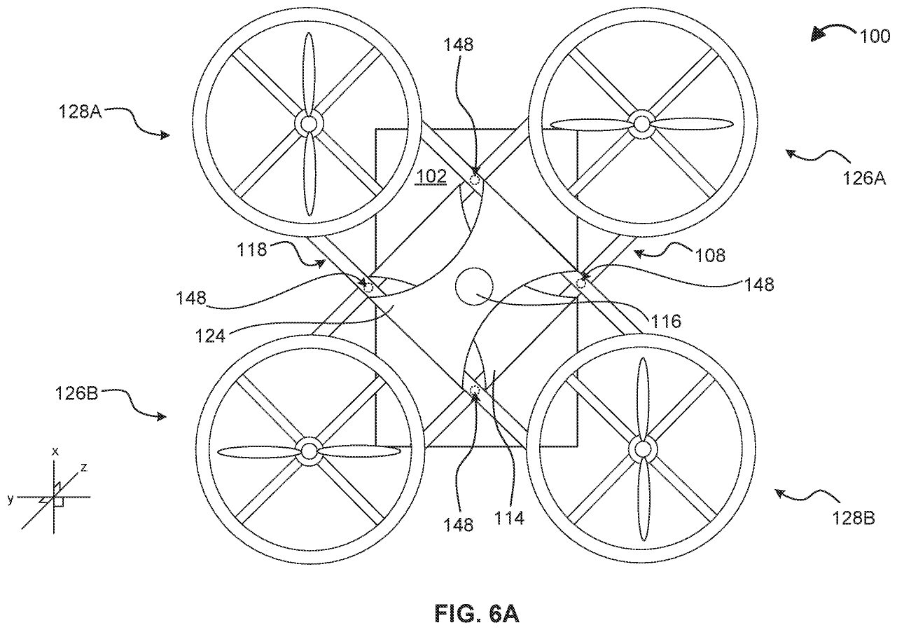

In one embodiment, the movable vehicle 100 may assume a closed and retracted configuration, as shown in the exemplary embodiment of FIGS. 5A-5D. For clarity, some of the features of the movable vehicle 100 are omitted in FIGS. 5A-5D. In the closed and retracted configuration, the longitudinal axis 110 of the first arm 108 is substantially coincident with the longitudinal axis 118 of the second arm 116, and (b) the longitudinal lengths, l₁, l₂, of first and second arms 108, 118, respectively are fully retracted (i.e., have achieved their minimum allowed value). This closed and retracted configuration may enable the movable vehicle 100 to assume an overall smaller size for ease of transport and storage.

The closed and retracted configuration may also encompass instances in which propulsion units 124A and 124B are positioned directly above (i.e., superposed on) propulsion units 122A and 122B, respectively (see, e.g., FIG. 5B), and instances in which propulsion units 124A and 124B are positioned directly above (i.e., superposed on) propulsion units 122B and 122A, respectively (see, e.g., FIG. 5B) due to the ability of at least one of the arms 108, 118 to rotate about the vertical axis 106 of the main body 102 in a clockwise or counterclockwise direction. Furthermore, in the closed and retracted configuration, the longitudinal axes 110, 120 of the first and second arms 108, 118, respectively, may be substantially coincident with each other and the longitudinal axis 144 of the main body 102 (see, e.g., FIG. 5D), or substantially coincident with each other and the lateral axis 146 of the main body 102.

It is of note that the movable vehicle 100 may achieve any number of configurations, not just the open and extended, open and retracted, closed and extended, and closed and retracted configurations illustrated in the respective FIGS. For example, the movable vehicle 100 may assume any number of intermediate configurations in which the, relative, horizontal angle between the longitudinal axes 110, 120 of the first and second arms 108, 118, respectively, ranges from greater than about 0° to less than about 90°, and/or the first and second arms 108, 118 have longitudinal lengths that range from less than full extension to greater than full retraction.

In some embodiments, the first and second arms 108, 116, and particularly the support members thereof (112A/112B, 118A/118B), may be configured so as to allow the retraction and expansion of the longitudinal lengths, l₁ and l₂, of the first and second arms 108, 118, respectively. This longitudinal motion may be achieved by any suitable sliding, cinching, ratcheting, telescoping, or adjustment mechanism as would be appreciated by skilled artisans upon reading the present disclosure. For instance, in one embodiment, each support member may comprises at least two components (e.g., bars, rods, etc.) slidably coupled together (not shown in the aforementioned FIGS.). In one such embodiment, the outer surfaces/peripheries of these two components may be adjacent (e.g., side by side) and may slide past each other to achieve a desired longitudinal length of the respective arm. In another such embodiment, one of the components may have an interior cavity region with a suitable size, shape, and/or dimensions to allow the other component to enter within said interior cavity region so as to achieve a desired longitudinal length of the respective arm.

While also not shown in the aforementioned FIGS., the movable vehicle 100 may comprise one or more locking mechanisms configured to maintain a certain configuration thereof. For instance, in some embodiments, the movable vehicle 100 may comprise a locking mechanism configured to maintain a desired longitudinal length of each arm 108, 118. In some embodiments, the movable vehicle 100 may also comprise a locking mechanism configured to maintain a certain horizontal angle between the longitudinal axes 110, 120 of each arm 108, 118, respectively. Such locking mechanism(s) may secure the movable vehicle 100 in any of the configurations described herein (e.g., the open and extended configuration, the open and retracted configuration, the closed and extended configuration, the closed and retracted configuration, etc.).

Exemplary locking mechanisms may include, but are not limited to, physical/mechanical locks, magnetic locks, electromagnetic locks, combinations thereof, or any suitable locking mechanism as would be appreciated by skilled artisans upon reading the present disclosure. In some embodiments, such locking mechanisms may be affixed to one or more portions of the main body 102. In some embodiments, a locking mechanism may be affixed to one or more portions of at least one arm (108 and/or 118). For example, in one embodiment, a locking mechanism may be present between the arms 108, 118.

FIGS. 6A-6B show an exemplary embodiment in which a locking mechanism configured to lock the movable vehicle 100 in the open or closed configuration may be present in one or more regions 148 of at least one of the arms 108, 118. These regions 148 may correspond to points of intersection when the arms 108, 118 are positioned in the open configuration (FIG. 6A) and/or closed configuration (FIG. 6B). In some embodiments, this locking mechanism may comprise a physical/mechanical locking means. For instance, at least one region 148 may comprise one or more receptacles in which a pin/rod may be inserted to lock the arms 108, 118 in the open and/or closed configuration. In some embodiments, the locking mechanism may comprise magnetic or electromagnetic means. For instance, in at least one region 148, the arms 108, 118 may comprise one or more magnets that attract one another when in proximity thereto.

In some embodiments, transformation of the movable vehicle 100 between the configurations described herein may be achieved manually, e.g., by a user physically rotating the first and/or second arms 108, 118 about the vertical axis 106 of the main body 102, and/or adjusting the length of at least one of said arms. In some embodiments, the transformation of the movable vehicle 100 may be controlled by a suitable control system coupled to (e.g., mounted on) the vehicle 100. This control system may include a communication module configured to receive user input/commands. For instance, the user input/commands may include instructions to rotate at least one of the arms to achieve an open configuration (e.g., for flying purposes) or a closed configuration (e.g., for transport and/or storage purposes). Similarly, the user input/command may include instructions to adjust the longitudinal length of at least one of the arms to achieve an extended or retracted configuration. In some embodiments, the user input/commands received by the communication module (or a receiver associated therewith) may be sent from a remote terminal or device.

The movable vehicle 100 may comprise a suitable actuation system configured to actuate the first and/or second arm 108, 118 to achieve a desired configuration. In some embodiments, the actuation system may be comprised within the cavity region of the main body 102 of the movable vehicle 100. The actuation system may comprise any suitable actuation element or elements such as gears, shafts, pulleys, screws, nuts, spindles, belts, axles, wheels, etc. This actuation system may also comprises at least one motor (DC brushed or brushless motor), AC motor, servo motor, stepped motor, etc. In some embodiments, a single actuation system (and motor) may be configured to actuate both the first and second arms 108, 118. In some embodiments, the first and second arms 108, 118 may be independently actuated via separate actuation systems (and respective motors). For instance, in one such exemplary embodiment, each arm 108, 118 may be actuated between the open and closed configurations, as well as the extended and retracted configuration, by one or more servo motors, allowing for precise rotational and/or linear motion.

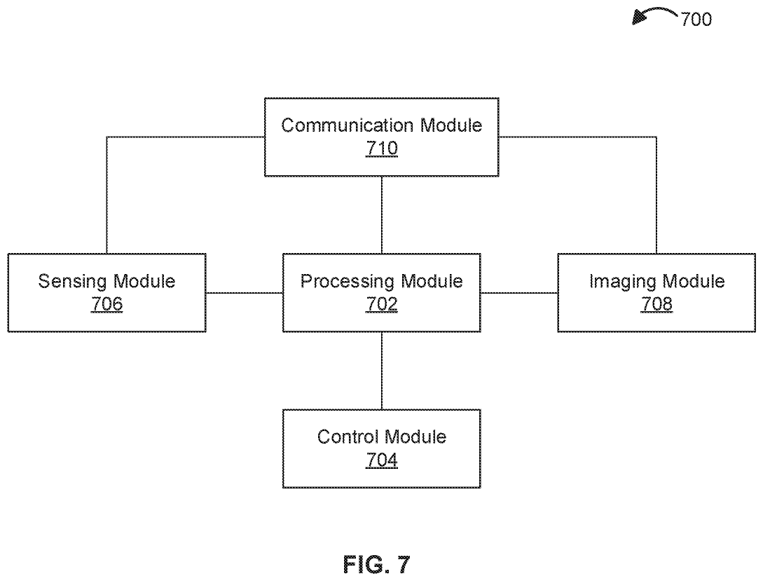

Referring now to FIG. 7, a simplified block diagram of a control system 700 for controlling a movable vehicle (such described herein), is provided according to one exemplary embodiment. The control system 700 may be implemented in combination with other devices/features/components described herein, such as those described with reference to other embodiments and FIGS. The control system 700 may also be used in various applications and/or in permutations, which may or may not be noted in the illustrative embodiments described herein. For instance, the control system 700 may include more or less features/components than those shown in FIG. 7, in some embodiments.

As shown in FIG. 7, the control system 700 may include at least a processing module 702, a control module 704, a sensing module 706, an imaging module 708, and a communication module 710.

The processing module 702 may have one or more processors, such as a central processing unit (CPU). The processing module 702 may also be operatively coupled to a non-transitory computer readable medium comprising memory (e.g., removable media or external storage such as an SD card or random access memory (RAM)). The memory of the non-transitory computer readable medium may store logic, code and/or program instructions executable by the processing module 702 to cause said processing module 702 to perform various operations as described herein.

In some embodiments, the processing module 702 may be operatively coupled to the control module 704. The control module 704 may be configured to control a function, state, and/or configuration of the movable vehicle 100. For example, the control module 704 can be configured to control the propulsion units 126A/126B, 128A/128B of the movable vehicle 100 to adjust the velocity, acceleration, deceleration, spatial disposition, etc. of the aircraft with respect to translational and/or rotation movement. The control module 704 may also be configured to control one or more of the sensing module 706, imaging module 708, payload, and/or other devices/components associated with the vehicle 100.

In some embodiments, the processing module 702 may be operatively coupled to the sensing module 706. The sensing module 706 may comprise one or more sensors, some of which may the same (e.g., collect the same types of signals or information) or may be different from one another (e.g., collect different types of signals or information). Exemplary sensors include, but are not limited to, inertial sensors, GPS sensors, proximity sensors, a radar sensors, vision/image sensors, etc. In some embodiments, data collected by the sensing module 706 may be transmitted to and stored within the memory of the non-transitory computer readable medium.

In some embodiments, the processing module 702 may be operatively coupled to the imaging module 708, which may comprise one or more imaging devices (e.g., cameras, video recorders, etc.). In some embodiments, images captured by the imaging module 708 may be transmitted to and stored within the memory of the non-transitory computer readable medium.

In some embodiments, the processing module 702 may be operatively coupled to the communication module 710. The communication module 710 may be configured to transmit and/or receive data from one or more external devices (e.g., a terminal, display device, remote device (e.g., remote controller), etc.) via wired and/or wireless networks. In some embodiments, the communication module 710 may be configured to utilize one or more of local area networks (LAN), wide area networks (WAN), infrared, radio, WiFi, point-to-point (P2P) networks, telecommunication networks, the Internet, cloud communication networks, etc. to transmit and/or receive data. In some embodiments, relay stations such as towers, satellites, or mobile stations may be optionally used for such communication. Moreover, line-of-sight may or may not be required for communication in some embodiments.

In some embodiments, the communication module 710 may also be operatively coupled to the sensing module 706 and/or the imaging module 708. In such embodiments, the communication module 706 may be configured to directly transmit data collected from at least one of the sensors associated with the sensing module 706 to one or more external devices. Additionally, the communication module 706 may be configured to directly transmit images captured by at least one imaging device associated with the imaging module 708 to one or more external devices.

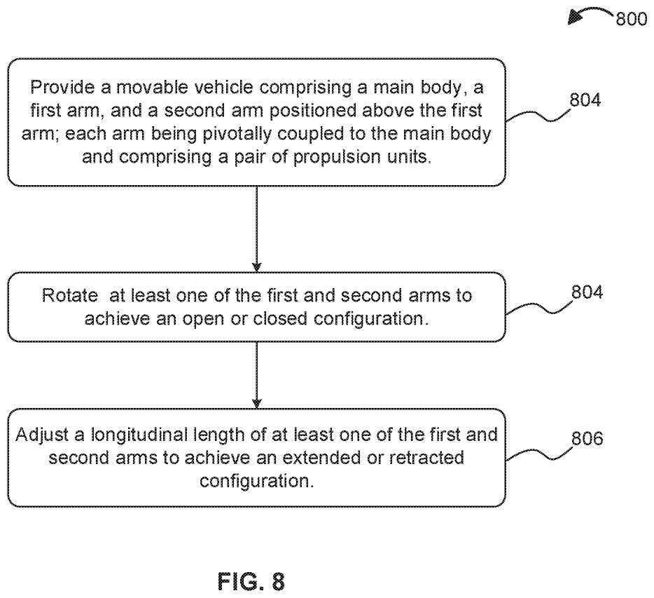

Referring now to FIG. 8, a method 800 for transforming a movable vehicle, e.g., as described herein, between two or more configurations is shown according to one exemplary embodiment. The method 800 may be implemented in conjunction with any of the devices/features/components described herein, such as those described with reference to other embodiments and FIGS. The method 800 may also be used for various applications and/or according to various permutations, which may or may not be noted in the illustrative embodiments described herein. For instance, the method 800 may include more or less operations/steps than those shown in FIG. 8, in some embodiments.

As shown in FIG. 8, the method 800 comprises providing a movable vehicle comprising a main body, a first arm, and a second arm positioned above the first arm, wherein each arm is pivotally coupled to the main body and comprises a pair of propulsion units at opposite ends thereof. See operation 802. Each arm may also comprise a longitudinal axis and as well as a longitudinal axis, as described herein.

In some embodiments, the movable vehicle is an unmanned aerial vehicle (UAV) configured to achieve one or more configurations (e.g., configurations that enable the UAV to land, take off, or fly; configurations that enable the UAV to assume a compact shape for ease of transport and/or storage, etc.). In some embodiments, rotation of at least one of the arms relative to the main body and/or relative to the other arm may result in different configurations. Different configuration may also result for different longitudinal lengths of at least one of the arms.

Accordingly, the method 800 comprises rotating at least one of the first arm or the second arm to achieve an open or closed configuration. See operation 804. As described herein, a horizontal angle between the longitudinal axis of the first arm and the longitudinal axis of the second arm may be in range from greater than 0° to about 90° in the open configuration. In some embodiments, the horizontal angle between the longitudinal axis of the first arm and the longitudinal axis of the second arm may be about 90° in the open configuration. As also described herein, a horizontal angle between the longitudinal axis of the first arm and the longitudinal axis of the second arm may be about 0° in the closed configuration such that the second arm is substantially superposed on the first arm.

The method 800 additionally comprises adjusting a longitudinal length of at least one of the first arm or the second arm to achieve an extended or retracted configuration. See operation 806. As described herein, each arm may have a maximum longitudinal length in the extended configuration, and a minimum longitudinal length in the retracted configuration.

In some embodiments, rotation of at least one of the arms occurs prior to adjusting the longitudinal length of at least one of the arms. In some embodiments, rotation of at least one of the arms occurs after adjusting the longitudinal length of at least one of the arms.

In some embodiments, the method 800 may comprise rotating at least one of the first arm or the second arm to achieve the open configuration, and adjusting the longitudinal length of both arms to achieve the extended configuration. In some embodiments, the method 800 may comprise rotating at least one of the first arm or the second arm to achieve the open configuration, and adjusting the longitudinal length of both arms to achieve the retracted configuration. In some embodiments, the method 800 may comprise rotating at least one of the first arm or the second arm to achieve the closed configuration, and adjusting the longitudinal length of both arms to achieve the extended configuration. In some embodiments, the method 800 may comprise rotating at least one of the first arm or the second arm to achieve the closed configuration, and adjusting the longitudinal length of both arms to achieve the retracted configuration.

The foregoing description of the present disclosure has been provided for the purposes of illustration and description. It is not intended to be exhaustive or to limit the disclosure to the precise forms disclosed. The breadth and scope of the present disclosure should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the disclosure and its practical application, thereby enabling others skilled in the art to understand the disclosure for various embodiments and with various modifications that are suited to the particular use contemplated. It is intended that the scope of the invention be defined by the following claims and their equivalence.

What is claimed is:

1. A movable vehicle, comprising:
a main body;
a first arm and a second arm each connected to the main body;
a first pair of propulsion units positioned at opposite ends of the first arm; and
a second pair of propulsion units positioned at opposite ends of the second arm,
wherein at least one of a longitudinal length of the first arm or a longitudinal length of the second arm is adjustable between an extended configuration and a retracted configuration.

2. The movable vehicle of claim 1, wherein the first pair of propulsion units are coplanar with a horizontal plane.

3. The movable vehicle of claim 2, wherein:
the horizontal plane is a first horizontal plane; and
the second pair of propulsion units are coplanar with a second horizontal plane positioned below the first horizontal plane.

4. The movable vehicle of claim 1, wherein at least one of the first arm or the second arm is configured to rotate about a vertical axis of the main body to allow superposition of one or more portions of the first pair of propulsion units with one or more portions of the second pair of propulsion units.

5. The movable vehicle of claim 4, wherein the at least one of the first arm or the second arm is configured to rotate about the vertical axis between an open configuration and a closed configuration.

6. The movable vehicle of claim 5, wherein the closed configuration corresponds to the superposition of the one or more portions of the first pair of propulsion units with the one or more portions of the second pair of propulsion units.

7. The movable vehicle of claim 6, wherein a longitudinal axis of the first arm is substantially coincident with a longitudinal axis of the second arm in the closed configuration.

8. The movable vehicle of claim 5, wherein a longitudinal axis of the first arm is substantially orthogonal to a longitudinal axis of the second arm in the open configuration.

9. The movable vehicle of claim 5, further comprising at least one locking mechanism configured to lock the first arm and the second arm in the open configuration or the closed configuration.

10. The movable vehicle of claim 4, wherein the vertical axis passes through a center of weight of the main body.

11. The movable vehicle of claim 1, wherein the longitudinal length of the first arm and the longitudinal length of the second arm are each independently adjustable between the extended configuration and the retracted configuration.

12. The movable vehicle of claim 11, wherein the longitudinal length of the first arm and the longitudinal length of the second arm each comprise a maximum, predetermined value in the extended configuration.

13. The movable vehicle of claim 11, wherein the longitudinal length of the first arm and the longitudinal length of the second arm each comprise a minimum, predetermined value in the retracted configuration.

14. The movable vehicle of claim 11, further comprising at least one locking mechanism configured to lock the first arm and the second arm in the extended configuration or the retracted configuration.

15. The movable vehicle of claim 1, wherein one propulsion unit of the first pair of propulsion units and the second pair of propulsion units comprises a rotor.

16. The movable vehicle claim 15, wherein the one propulsion unit further comprises a protective shield configured to protect the rotor of the one propulsion unit.

17. The moveable vehicle of claim 16, wherein the protective shield comprises a central hub, a peripheral region, and one or more protective spokes extending radially from the central hub to the peripheral region.

18. The moveable vehicle of claim 17, wherein the central hub of the protective shield is coupled to a drive shaft of the rotor.

19. The movable vehicle of claim 1, wherein the movable vehicle is an unmanned movable vehicle.
